(19) United States
(12) Patent Application Publication
(10) Pub. No.: US 2026/0233088 A1
(43) Pub. Date: Aug. 13, 2026

(54) SCRATCH-OFF LOTTERY TICKET SYSTEM WITH MULTIPLIER FEATURE

(71) Applicant: Scientific Games, LLC, Alpharetta, GA (US)

(72) Inventors: Danielle L. Hodges, Dawsonville, GA (US); Scott B. Garrison, Duluth, GA (US)

(21) Appl. No.: 19/048,342

(22) Filed: Feb. 7, 2025

(51) Int. Cl. A63F 3/06

(52) U.S. Cl. CPC A63F 3/0665

(57) ABSTRACT

A scratch-off lottery ticket system includes a set of lottery tickets, with each ticket having a game play area with grid lines that define grid spaces with a game symbol therein. At least one of the game symbols in the game play area corresponds to a winning symbol to win a prize. Matched grid spaces have a matching pattern of grid lines that differentiates the matched grid spaces from other grid spaces. Characteristics of the matching pattern determines a multiplier value applied to the prize.

### FIELD OF THE INVENTION

The present invention generally relates to a system and individual tickets for a scratch-off lottery ticket game, and more particularly to a system and tickets with an enhanced multiplier function.

### BACKGROUND

“Scratch-off” or “instant-win” lottery tickets have enjoyed immense popularity in the lottery industry for decades. These games offer distinct advantages to the lottery authorities and are attractive to a broad spectrum of players.

The scratch-off lottery ticket games typically have a multi-tiered prize structure with relatively fewer prizes at the top tier level and a greater number of prizes at the lower tier levels. In order to make these games more attractive to players, it is common to incorporate a “multiplier” enhancement into the tickets wherein, upon satisfying certain conditions enabled by the game indicia underlying the scratch-off layer, the prize awarded for matching game symbols is multiplied by a factor, for example a 2× or 3× multiplier.

An example of this feature is seen in the “Linked Wins” scratch-off lottery tickets offered by the Hoosier Lottery (Indiana, USA). In the Linked Wins game, one or more pairs of adjacent game spaces underlying the scratch-off coating are linked together by a color-coded, barbell-shaped symbol that bridges across the spaces, wherein the color of the symbol dictates the multiplier value (i.e., 2×, 5×, or 10×). If the player's number in each of the linked spaces matches one of the “winning numbers”, respectively, then the total prize for both of the matches is multiplied by the multiplier value associated with the color-coded linking symbol. If only one of the player's number in the linked spaces matches a winning number, then the multiplier does not apply.

As with essentially all scratch-off lottery ticket games, the status (winning or losing) and prize value of each ticket is predetermined and fixed within the multi-tiered prize structure. The presence or absence of a multiplier does not change the predetermined status/prize value of the ticket. Even so, the multiplier feature has become an entertaining and sought-after feature valued by players. Lottery tickets for games with a multiplier feature will generally sell better than tickets for comparable games without the multiplier feature. It is thus important to the lottery industry (and the municipalities and entities that benefit from the sale of lottery tickets) to continuously evolve and express the multiplier experience for players in new and innovative ways.

### SUMMARY

Objects and advantages of the invention will be set forth in part in the following description, or may be obvious from the description, or may be learned through practice of the invention.

In a particular embodiment of the present invention, a system is provided for play of scratch-off lottery tickets having a new and entertaining multiplier feature. The system includes a total set of scratch-off lottery tickets generated for the game (“the ticket run” for the game). A single multi-tier prize structure is established for the game that includes at least one top tier prize and a plurality of prizes at lower-tier prize levels. Within this system, each of the scratch-off lottery tickets includes a substrate with a game play area defined thereon and covered by a scratch-off coating. The game play area has a plurality of grid lines that define a plurality of individual grid spaces, each grid space having a game symbol printed therein. The substrate also includes a winning symbol area defined thereon that identifies one or more winning symbols. In order to win one or more of the prizes, at least one of the game symbols in the game play area must correspond to one of the winning symbols. At least two of the grid spaces are identified as matched grid spaces by a matching pattern of the grid lines that differentiates the matched grid spaces from other grid spaces. The particular characteristic(s) of the matching pattern determines a multiplier value. When the game symbol in each of matched grid spaces also corresponds to one of the winning symbols, a total prize associated with the matching symbols from both of the matched grid spaces is multiplied by the multiplier value.

In a particular embodiment, the matching pattern of the grid lines includes a visually enhanced characteristic of the grid lines at a same side location for each of the matched grid spaces. For example, the visually enhanced characteristic may be located at the bottom side of the grid spaces, or the bottom side and one or both of the vertical sides of the grid spaces, or even all of the sides of the grid spaces. The multiplier value may increase as a function of a number of sides of the matched grid spaces that have the visually enhanced characteristic.

The scope of the visually enhanced characteristic may vary. For example, the characteristic may be any one or combination of: line darkness, number of adjacent lines, dashed or broken line segments, or line color.

In another embodiment, it is the type of visually enhanced characteristic that determines the multiplier value, not necessarily the number of sides. For example, the characteristic may be the type or appearance of the lines that define a complete enclosed game space.

In a certain embodiment, the matched grid spaces may be remote from each other in the game play area. Alternatively, the matched grid spaces may be adjacent to each other in the game play area. The adjacent spaces may share a common side that includes the visually enhanced characteristic.

In yet another embodiment, the matched grid spaces comprise at least three of the grid spaces having the same matching pattern of grid lines, wherein the multiplier value is a function of a number of the matched grid spaces that contain one of the winning symbols.

In still another embodiment, the matched grid spaces may include a first set and a second set, wherein the matching pattern of the grid lines in the first set is different than the matching pattern of the grin lines in the second set, and wherein the multiplier value is different for the first and second sets.

The present disclosure also encompasses the individual scratch-off lottery tickets discussed above as stand-alone invention.

### BRIEF DESCRIPTION OF THE DRAWINGS

A full and enabling disclosure including the best mode of practicing the appended claims and directed to one of ordinary skill in the art is set forth more particularly in the remainder of the specification. The specification makes reference to the appended figures, in which:

FIG. 1 depicts a game system with scratch-off lottery tickets specifically configured for use in the present invention, as well as a tiered prized structure for the game;

FIG. 2 is an embodiment of a scratch-off lottery ticket in accordance with aspects of the present invention;

FIG. 3 is an embodiment of a scratch-off lottery ticket in accordance with aspects of the present invention;

FIG. 4 is an embodiment of a scratch-off lottery ticket in accordance with aspects of the present invention; and

FIG. 5 is an embodiment of a scratch-off lottery ticket in accordance with aspects of the present invention.

### DETAILED DESCRIPTION

Reference will now be made in detail to various and alternative exemplary embodiments and to the accompanying drawings, with like numerals representing substantially identical structural elements. Each example is provided by way of explanation, and not as a limitation. In fact, it will be apparent to those skilled in the art that modifications and variations can be made without departing from the scope or spirit of the disclosure and claims. For instance, features illustrated or described as part of one embodiment may be used on another embodiment to yield a still further embodiment. Thus, it is intended that the present disclosure includes modifications and variations as come within the scope of the appended claims and their equivalents.

Generally, the present disclosure is directed to a scratch-off lottery ticket game system (as well as individual scratch-off lottery tickets) that provides an enticing and entertaining multiplier function to the individual lottery tickets.

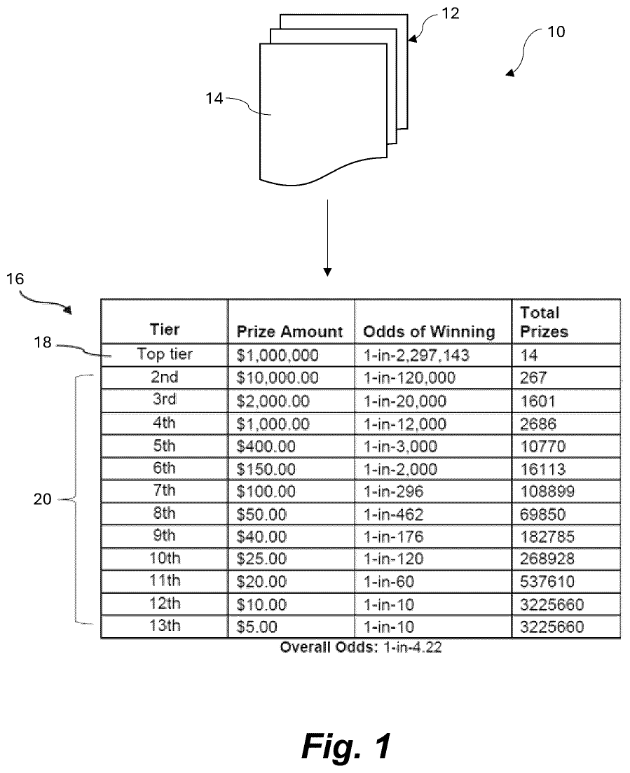

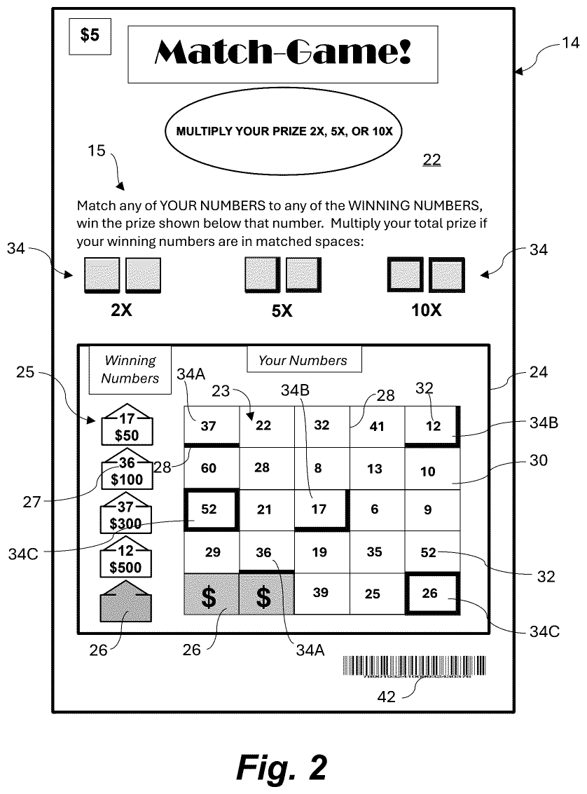

In an embodiment of the system depicted in FIG. 1, the scratch-off lottery ticket game system 10 includes a set 12 of scratch-off lottery tickets 14 that may be generated for a common game (“the ticket run” for the game). For example, the total set 12 would encompass all of the scratch-off lottery tickets 14 produced for the “Match-Game!” game tickets (FIG. 2).

Referring to FIG. 1, a single multi-tier prize structure 16 is established for the game that includes at least one top tier prize 18 and a plurality of lower-tier prize levels 20. For example, in the depicted embodiment, there are fourteen (14) top tier prizes 18 of $1,000,000 each. A plurality of subsets of the lower tier prizes 20 are also depicted. As understood, the total set 12 of scratch-off lottery tickets 14 is defined, wherein the number of the tickets 14 in the top tier 18 and each of the lower tier 20 subsets is predetermined. The winning outcome of each of the lottery tickets 14 in the top tier 18 and lower tier 20 is also predetermined. For example, referring to FIG. 1, there is a subset of 267 tickets assigned to the 2^{nd} lower tier prize level 20, with each ticket having a predetermined prize value of $ 10,000. There is another subset of 1601 tickets assigned to the 3^{rd} lower tier prize level 20, with each ticket having a predetermined prize value of $2,000. The additional subsets and associated lower-tier prize levels 20 are readily understood from FIG. 1.

FIG. 2 depicts an embodiment of a scratch-off lottery ticket 14 that is uniquely configured for the present game system 10. The ticket 14 includes game instruction graphics and indicia 15 printed thereon that explain to a player how to play the game embodied on the ticket 14, as well as what constitutes a winning ticket and the prize amounts. The game instruction indicia 15 may be considered as “static” indicia in that, for a given common game, it does not change from one ticket 14 to the other.

The tickets 14 may be printed paper tickets, or may be electronically simulated tickets 14 that are transmitted to and played by the player via an application running on a smart device, such as a mobile phone, tablet, computer, etc.

Still referring to FIG. 2, as is well known to players of scratch-off lottery tickets, each ticket 14 includes a substrate 22 (e.g., a paper base) with a game play area 24 provided thereon that includes variable game play indicia 23, which determines the winning or losing status of the ticket 14. The game play indicia 23 is covered by a scratch-off coating (SOC) layer 26. FIG. 2 depicts that a player has removed (e.g., scratched off) the layer 26 from most of the game play indicia 23 in order to reveal the status of the ticket 14. Thus, the game play indicia 23 is “variable” indicia in that it changes from one ticket 14 to another.

In the depicted game embodied by the ticket 14 in FIG. 2, the player is presented with a series (5) of symbols 27 in a winning symbols area 25 at the left-hand side of the game play area 24 (designated as “Winning Numbers”), which are also initially covered by the SOC layer 26. A winning symbol 27 (e.g., a number, letter, or other type of symbol) is presented in each of the covered spaces in the winning symbols area 25.

The game play area 24 includes a matrix of grid spaces 30 defined by grid lines 28. A game symbol 32 is printed or otherwise provided in each grid space 30 (designated as “Your Numbers’), wherein the game symbols correspond to the type of symbols 27 in the winning symbols area 25 (e.g. a number, letter, or the like). The game instruction indicia 15 conveys to the player that a match of any of the “Your Numbers” with any of the “Winning Numbers” wins the prize show below the number.

In FIG. 2, the matrix of grid spaces 30 is depicted as a four-sided grid for illustrative purposes only. The grid spaces 30 may be defined by the grid lines 28 in any desired pattern, such as a circular or other multi-sided pattern.

Still referring to FIG. 2, each lottery ticket 14 in the game system provides a potential multiplier function that is explained by the game instruction indicia 15. For example, in FIG. 2 a multiplier value is applied when two winning numbers (i.e., two game symbols 32 match two winning symbols 27) are in a pair matched grid spaces 34 identified on the lottery ticket 14, wherein the matched grid spaces 34 correspond to at least two of the grid spaces 30 that have a matching pattern of the grid lines 28 that differentiates the matched grid spaces 34 from other grid spaces 30. As explained further below, characteristics of the matching pattern of grid lines determines a multiplier value. When the game symbol 32 in each of matched grid spaces 34 also matches one of the winning symbols 27, a total prize associated with the matching symbols for each of the matched grid spaces 34 is multiplied by the multiplier value.

The matching pattern of the grid lines 28 that defines the matched grid spaces 34 may be a visually enhanced characteristic of the grid lines 28 at a same side location for each of the matched grid spaces 34. For example, referring to FIG. 2, the visually enhanced characteristic of the grid lines 28 is a wider or darker line at particular locations of the grid space. A first example of a set or pair of matched grid spaces 34A includes wider/darker grid lines at the bottom side of the game spaces 30, which provides a 2× multiplier. A second example of a set or pair of matched grid spaces 34B includes wider/darker grid lines at the bottom and right-hand sides of the game spaces 30, which provides a 5× multiplier. A third example of a pair or set of matched grid spaces 34C includes wider/darker grid lines at all of the sides of the game spaces 30, which provides a 10× multiplier. For the ticket 14 in FIG. 2, the matched grid spaces 34A include game symbols “36” and “37” that match winning symbols 27. Thus, the total prize of $400 ($100+$300) is multiplied by 2× for a winning prize amount of $800. Similarly, the matched grid spaces 34B include game symbols “17” and “12” that match winning symbols 27. Thus, the total prize of $550 ($50+$500) is multiplied by 5× for a winning prize amount of $2,750. The ticket 14 thus has a total winning prize value of $3,550.

FIG. 2 is thus an example wherein the number, location, and width/color of the grid lines 28 that define the matched grid spaces 34 determine the multiplier value. Any one or combination of these grid line characteristics may be used to identify sets or pairs of matched grid spaces 34 and the multiplier value assigned thereto.

It should be noted that in the embodiment of FIG. 2, the pairs of matched grid spaces 34A, 34B, and 34C may be remote (not adjacent to each other) but adjacent spaces are not precluded.

It should also be appreciated that although three different sets or pairs of matches grid space 34A, 34B, and 34C are depicted on the ticket 14 with each set having a different visually enhancing grid line characteristics and associated multiplier values, an embodiment may be provided with fewer (e.g. one or two) sets or a greater number of sets (e.g., four or five).

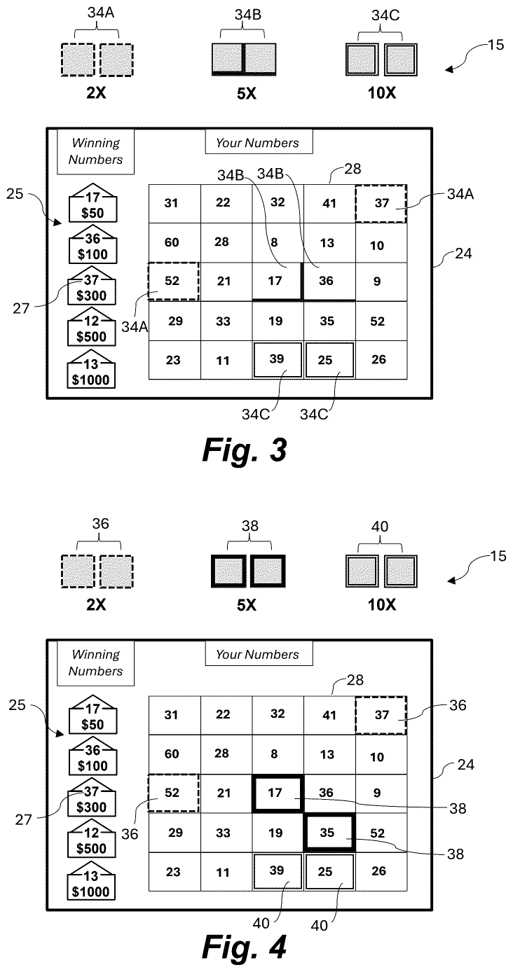

FIG. 3 depicts aspects of another ticket embodiment that identifies the possibility of three different multiplier values assigned to three different pairs matched grid spaces 34A, 34B, 34C. The visually enhanced characteristic of the grid lines 28 defining the matched grid spaces 34A is a dashed line that completely encloses the grid spaces 34A. The visually enhanced characteristic of the grid lines 28 defining the matched grid spaces 34B is a wide/dark line at the common shared side of two adjacent grid spaces 30 and the bottom side of each of the grid spaces. The visually enhanced characteristic of the grid lines 28 defining the matched grid spaces 34C is a double line that completely encloses the grid spaces 34A. For the pairs of matched grid spaces 34A and 34C, the grid spaces are remote (but could be adjacent). For the pair of matched grid spaces 34B, the grid spaces must be adjacent to each other.

FIG. 4 depicts aspects of another ticket embodiment that identifies the possibility of three different multiplier values assigned to three different pairs matched grid spaces 34A, 34B, 34C. The visually enhanced characteristic of the grid lines 28 defining each pair of matched grid spaces 34A, 34B, 34C is not a function of the number of effected sides of the grid spaces (all pairs 34A, 34B, and 34C have completely enclosed grid spaces), but the type of grid line. For the pair of matched grid spaces 34A, the visually enhanced characteristic is dashed lines. The visually enhanced characteristic of the grid lines 28 defining the matched grid spaces 34B is a wide/dark line. The visually enhanced characteristic of the grid lines 28 defining the matched grid spaces 34C is a double line. For the pairs of matched grid spaces 34A, 34B, and 34C, the grid spaces are remote (but could be adjacent).

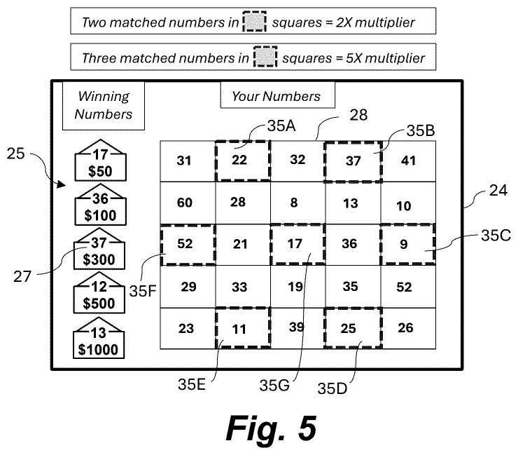

FIG. 5 depicts aspects of a lottery ticket for use in the system wherein the set of matched grid spaces includes seven different grid spaces (35A through 35F) each having the same matching pattern of grid lines (e.g. dashed lines completely surrounding the grid spaces). The multiplier value in this example is a function of a number of the matched grid spaces (34A-34F) that contain one of the winning symbols. For example, two matched numbers provides a 2× multiplier and three matched numbers provides a 3× multiplier. In the depicted embodiment, the matched spaces 35B and 35G contain game symbols that match one of the winning symbols 27. Thus, the total prize of $350 ($50+$300) is multiplied by 2× for a winning prize amount of $700.

Referring to the ticket 14 in FIG. 12, each ticket may include a validation code 42 printed thereon, which may also be covered by a SOC layer, that links the ticket 14 to a validation file contained in a central server or computer system. Those skilled in the art appreciate that the validation file contains ticket-specific information for validation and pay-out (redemption) of the ticket 14, including whether or not the ticket is a winning ticket and the predetermined prize value of the ticket 14.

The present invention also encompasses one or more of the lottery tickets 14 discussed above as a stand-alone invention.

The material particularly shown and described above is not meant to be limiting, but instead serves to show and teach various exemplary implementations of the present subject matter. As set forth in the attached claims, the scope of the present invention includes both combinations and sub-combinations of various features discussed herein, along with such variations and modifications as would occur to a person of skill in the art.

What is claimed is:

1. A system for providing scratch-off lottery tickets with a prize multiplier feature, comprising:
a set of the scratch-off lottery tickets for play in a game having a plurality of prizes in a multi-tier prize structure;
each of the scratch-off lottery tickets comprising:
a substrate with a game play area defined thereon and covered by a scratch-off coating, the game play area comprising a plurality of grid lines that define a plurality of grid spaces, each grid space comprising a game symbol therein;
a winning symbol area on the substrate that identifies one or more winning symbols, wherein at least one of the game symbols in the game play area corresponds to one of the winning symbols to win one or more of the prizes;
at least two of the grid spaces being matched grid spaces comprising a matching pattern of the grid lines that differentiates the matched grid spaces from other grid spaces, characteristics of the matching pattern determining a multiplier value; and
wherein when the game symbol in each of matched grid spaces also matches one of the winning symbols, a total prize associated with the matching symbols for each of the matched grid spaces is multiplied by the multiplier value.

2. The system of claim 1, wherein the matching pattern of the grid lines comprises a visually enhanced characteristic of the grid lines at a same side location for each of the matched grid spaces.

3. The system of claim 2, wherein the visually enhanced characteristic comprises any one or combination of: line darkness, number of adjacent lines, dashed or broken line segments, or line color.

4. The system of claim 2, wherein the multiplier value increases as a function of a number of sides of the matched grid spaces having the visually enhanced characteristic.

5. The system of claim 2, wherein the multiplier value increases as a function of a type of the visually enhanced characteristic.

6. The system of claim 2, wherein the matched grid spaces are remote from each other in the game play area.

7. The system of claim 2, wherein the matched grid spaces are adjacent to each other in the game play area.

8. The system of claim 7, wherein the matched grid spaces share a common side.

9. The system of claim 1, wherein the matched grid spaces comprise at least three of the grid spaces having the same matching pattern of the grid lines, wherein the multiplier value is a function of a number of the matched grid spaces that contain one of the winning symbols.

10. The system of claim 1, wherein the matched grid spaces comprise a first set and a second set, wherein the matching pattern of the grid lines in the first set is different than the matching pattern of the grid lines in the second set, and wherein the multiplier value is different for the first and second sets.

11. A scratch-off lottery ticket, comprising:
a substrate with a game play area defined thereon and covered by a scratch-off coating;
the game play area comprising a plurality of grid lines that define a plurality of grid spaces, each grid space comprising a game symbol therein;
a winning symbol area on the substrate that identifies one or more winning symbols, wherein at least one of the game symbols in the game play area corresponds to one of the winning symbols to win one or more of the prizes;
at least two of the grid spaces being matched grid spaces comprising a matching pattern of the grid lines that differentiates the matched grid spaces from other grid spaces, characteristics of the matching pattern determining a multiplier value; and
wherein when the game symbol in each of matched grid spaces also matches one of the winning symbols, a total prize associated with the matching symbols is multiplied by the multiplier value.

12. The scratch-off lottery ticket of claim 11, wherein the matching pattern of the grid lines comprises a visually enhanced characteristic of the grid lines at a same side location for each of the matched grid spaces.

13. The scratch-off lottery ticket of claim 12, wherein the visually enhanced characteristic comprises any one or combination of: line darkness, number of adjacent lines, dashed or broken line segments, or line color.

14. The scratch-off lottery ticket of claim 12, wherein the multiplier value increases as a function of a number of sides of the matched grid spaces having the visually enhanced characteristic.

15. The scratch-off lottery ticket of claim 12, wherein the multiplier value increases as a function of a type of the visually enhanced characteristic.

16. The scratch-off lottery ticket of claim 12, wherein the matched grid spaces are remote from each other in the game play area.

17. The scratch-off lottery ticket of claim 12, wherein the matched grid spaces are adjacent to each other in the game play area.

18. The scratch-off lottery ticket of claim 17, wherein the matched grid spaces share a common side.

19. The scratch-off lottery ticket of claim 11, wherein the matched grid spaces comprise at least three of the grid spaces having the same matching pattern of the grid lines, wherein the multiplier value is a function of a number of the matched grid spaces that contain one of the winning symbols.

20. The scratch-off lottery ticket of claim 11, wherein the matched grid spaces comprise a first set and a second set, wherein the matching pattern of the grid lines in the first set is different than the matching pattern of the grin lines in the second set, and wherein the multiplier value is different for the first and second sets.
